(19) United States
(12) Patent Application Publication
(10) Pub. No.: US 2001/0036423 A1
(43) Pub. Date: Nov. 1, 2001

(54) Dry analytical element

(75) Inventors: Kazuya Kawasaki, Saitama (JP); Kentaro Nakamura, Saitama (JP); Yoshikazu Amano, Saitama (JP)

Correspondence Address: Jules E. Goldberg, Esq., Reed Smith LLP, 375 Park Avenue, New York, NY, 10152, US

(73) Assignee: Fuji Photo Film Co., Ltd.

(21) Appl. No.: 09/812,802

(22) Filed: Mar. 20, 2001

(30) Foreign Application Priority Data
Mar. 22, 2000 (JP) 080270/2000
Mar. 22, 2000 (JP) 080271/2000

(51) Int. Cl. G01N 31/22

(52) U.S. Cl. 422/56; 422/58

(57) ABSTRACT

This invention provides a dry analytical element without any spreading layer wherein the upper surface of water impermeable support is partitioned by water impermeable frame body, and wherein reagent necessary for analysis is contained in the frame, and also provides a dry analytical element comprising water impermeable support and mesh layer which is applied on the water impermeable support, and this invention discloses the dry analytical element of the above description wherein hydrophilic polymer layer is provided between the water impermeable support and the mesh layer.

### FIELD OF THE INVENTION

This invention concerns with an analytical element, which is simple and easy and can rapidly analyze with a small amount of a sample in the fields of clinical assay.

### BACKGROUND OF THE INVENTION

Diagnosis of human disease by analyzing a sample such as blood or urine has been done historically for a long time. This analytical method is classified roughly into wet process and dry process.

According to the dry process using traditional dry analytical element, there is the case where the degradation of optical density in colorimetric analysis can be recognized, or where the analysis utilizing agglutination reaction, coagulation reaction, etc., is inapplicable.

The wet process means a measuring process after triggering detective reaction between sample and necessary reagent solution by pouring them into a container.

The problems of the wet process are that it needs a large quantity of sample and that it lacks simplicity and rapidity. That is to say, it is necessary with a sample of around 0.1-0.5 ml every one analytical item, and it requires considerable volume of sample when analyzes plurality of analytical items, loading heavy tiredness for those who are inspected especially in the case of blood analysis. In addition, regarding addition of reagent, wet process suffer troubles and requires long time because it needs addition of each reagent in every each container, and analytical instrument entirety becomes large-scale.

On the other hand, in the dry process, there is the case where degradation of optical density in colorimetric analysis appears and where measurement of reactions such as agglutination reaction or coagulation reaction is impossible.

An object of the invention is to provide an analytical element, which is simple and easy and can rapidly analyze with a small amount of sample, and besides, which enables to measure the reaction even when the degradation of optical density in colorimetric analysis appears, and in the case of reactions such as agglutination reaction or coagulation reaction.

Another object of the invention is to provide an analytical element which is simple and easy and can rapidly analyze with a small amount of sample, and besides, which enables to measure the reactions such as chemical reaction, enzyme reaction, immune reaction, agglutination reaction or coagulation reaction.

The main character of traditional dry analytical element is in a spreading layer. That is to say, the spreading layer keeps measurings stability by spreading the components contained in the sample supplied to the dry analytical element flatly to feed them to the underneath layer with roughly constant rate per unit area without substantially unevendistribution. The research and development of this spreading layer achieved the dry analytical element for the first time.

However, as a result of having studied the calorimetric analysis of low optical density or the analysis using agglutination reaction, coagulation reaction by the dry analytical element, it was found that the existence of the spreading layer prohibits the calorimetric measurement of one part of the coloring matter generated among the spreading layer in case of colorimetric analysis, and that it also prohibits the measurement of the level of light scattering like turbidimetry.

It was understood that the reason why the above problem occurs was because the spreading layer functions as passive reflector and induces irregular reflection of projected light at the trial of reflection photometry from the optically transparent support side.

Therefore, the means that is not depended on the spreading layer and that could secure quantitativity were studied broadly. As a result, it was found that the quantitativity is secured by partitioning water impermeable sheet with water impermeable frame body, and that the sample can be analyzed with enough accuracy by letting reagent exist in frame partitioned with this frame body, and accordingly the measurement is possible even if the analytical reaction contains agglutination reaction, coagulation reaction in addition to colorimetric analysis.

In addition, it was found that the sample can be analyzed with enough accuracy by intervening reagent layer of dry analytical element between the frame body and the water impermeable sheet, and accordingly the measurement is possible even if the analytical reaction contains agglutination reaction, coagulation reaction as well as calorimetric analysis.

Moreover, it was found that the quantitativity is secured by combining mesh with water impermeable sheet and that the sample can be analyzed with enough accuracy by letting reagent exist in the mesh, and accordingly the measurement is possible even if the analytical reaction contains agglutination reaction, coagulation reaction as well as calorimetric analysis.

Furthermore, the invention was achieved by finding that the sample can be analyzed with enough accuracy by intervening reagent layer of dry analytical element between the mesh and the water impermeable sheet, and accordingly the measurement is possible even if the analytical reaction contains agglutination reaction, coagulation reaction as well as colorimetric analysis.

### SUMMARY OF THE INVENTION

According to the present invention, a dry analytical element that does not have the spreading layer is proposed, and water impermeable frame bodies partition the surface of water impermeable support of the proposed dry analytical element containing reagent that is necessary for analysis in the frame partitioned.

According to the present invention, a dry analytical element of the above description in which hydrophilic polymer layer is provided on the water impermeable support is also proposed.

In the dry analytical element of this invention, a constant amount of supplied sample is maintained in the partitioned frame, forming very small liquid column, and then, optionally existing hydrophilic polymer layer begin to dissolve therein to induce detection reaction with the reagent.

Besides, in the dry analytical element of this invention, a constant amount of supplied sample is maintained in the partitioned frame, forming very small liquid column, and this very small liquid column is absorbed by hydrophilic polymer layer to induce detection reaction.

According to the second invention, a dry analytical element that does not have the spreading layer in which a mesh layer is provided on the water impermeability support is also proposed.

Moreover, a dry analytical element of the above description is also proposed in this invention in which a hydrophilic polymer layer is provided between the water impermeable support and the mesh layer.

In the dry analytical element of the second invention, a substantially constant amount of supplied sample is maintained in each mesh, forming very small liquid column, and then hydrophilic polymer layer begins to dissolve in this very small liquid column to induce detection reaction with the reagent.

Besides, in the dry analytical element of the second invention, a substantially constant amount of supplied specimen is maintained in each mesh, forming very small liquid column, and then hydrophilic polymer layer to induce detection reaction with the reagent absorbs this very small liquid column.

### BRIEF DESCRIPTION OF THE DRAWINGS

FIG. 1 is a sectional view showing an example of structure of dry analytical element of this invention.

FIG. 2 is a sectional view showing another example of structure of dry analytical element of this invention.

FIG. 3 is a sectional view showing another example of structure of dry analytical element of this invention.

FIG. 4 is a perspective view of an example of dry analytical element of the second invention that used a net for the mesh layer.

FIG. 5 is a perspective view of an example of dry analytical element of the second invention which used a net for the mesh layer and further, which used a net for the mesh layer providing a reagent layer on itself.

FIG. 6 is a perspective view of an example of dry analytical element of the second invention that used punching sheet for the mesh layer and at the same time, which used a net for the mesh layer providing a reagent layer on itself.

### DESCRIPTION OF THE PREFERRED EMBODIMENTS

The invention is described herein with particular reference with materials used for the preferred embodiments of this invention.

As the water impermeable support, transparent support of water impermeability of public knowledge used for conventional dry analytical element can be applied. To be concrete, transparent film of from about 50 μm to 1 mm, desirably from about 80 μm to about 300 μm in thickness that consists of polyethylene terephthalate, polycarbonate of bisphenol A, polystyrene, cellulose ester (for example, cellulose diacetate, cellulose triacetate, cellulose acetate propionate, etc.), and so on can be used as the water-impermeable support.

The support may be provided with a well-known undercoating layer or with a well-known adhesion layer on its surface in order to strengthen the adhesion between the support and the hydrophilic polymer layer. In the case where any hydrophilic polymer layer is not provided, the surface of the support itself of a frame side of the dry analytical element must be hydrophilic at least in the degree that the specimen can spread on the entire surface in the block partitioned with the frame body. Therefore, when the support itself is repellent or hydrophobic, the support needs to be treated with hydrophilic treatment to the degree of above description.

The hydrophilic polymer layer should be provided on the support, and it is desirable not to let other layer exist between them than the above undercoating layer or the above adhesion layer. Typical examples of the hydrophilic polymer as a matrix forming the hydrophilic polymer layer are well-known various polymers such as water-soluble polymer, swelling polymer, and hydrophilic polymer used for conventional dry chemistry analytical elements. Typical examples of the hydrophilic polymers are polyvinyl alcohol, polyacrylamide, polyvinylpyrrolidone, polymethyl vinyl ether, copolymer of polyacrylamide and polyvinylpyrrolidone, methyl cellulose derivative, crosslinked starch-acrylate graft copolymer, crosslinked polyacrylic acid, gelatin (such as acid-treated gelatin, deionized gelatin, etc.), gelatin derivative (such as phthalated gelatin, hydroxyacrylate graft gelatin, etc.), carboxymethylstarch, and so on.

However, it is to be understood that the invention is not intended to be limited to the specific embodiments. It is desirable that the hydrophilic polymer layer is, in principle, transparent. The thickness of the hydrophilic polymer layer in dry state is properly from about 2 μm to about 100 μm, preferably from about 5 μm to about 50 μm.

Water-impermeable frame body maintains supplied sample in frame. The water-impermeable frame body should importantly prohibit the leakage of aqueous sample outside of itself. As the water-impermeable frame body, any material of no aperture is applicable. Besides, although there is space such as clearance, repellent material showing water impermeability by the repellency is also applicable as the water impermeable frame body.

The frame body is classified into single frame type and partitioned block type having 2 or more compartments blocks. Although the number of the compartments is not limited, from about 2 to about 100 compartments, preferably from 4 to 25 compartments are practical as concrete embodiments.

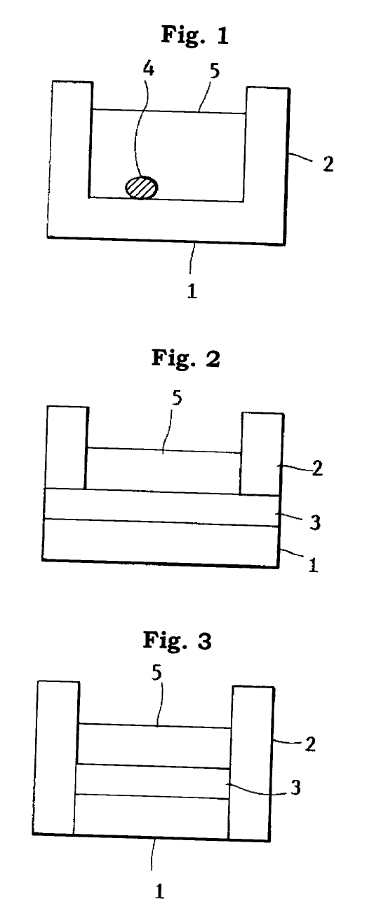

The frame body partitions off the surface of the water impermeable support; however, it does not end at the upper surface of the water impermeable support, and may reach the underside of the support. Examples as the concrete embodiments of the single frame type frame body are shown in FIG. 1, FIG. 2, and FIG. 3.

The mesh layer in the second invention maintains supplied aqueous sample substantially constant amount in itself by partitioning into every mesh. Configuration of each mesh is not particularly limited, and tetragon, hexagon, circle, etc. can be shown as example. Diameter indicating dimension of each mesh is adequately from about 0.05 mm to about 3.0 mm, preferably from 0.2 mm to 1.5 mm.

Besides, aperture diameter of mesh is suitably from about 0.05 mm to about 7.5 mm, and preferably from 0.4 mm to 6 mm. The thickness of the mesh layer is adequately from about 0.05 mm to about 6.0 mm, preferably from 0.2 mm to 3.0 mm.

Textile, a net, and punching sheet may be applied as the mesh layer.

When the configuration of mesh is circular, the mesh layer is produced by providing many circular holes after the dissolution of the water-soluble material from the sheet made by coating the suspension or emulsion liquid adding the water-soluble material in the solution of water-insoluble material or chemical agents in which the water-insoluble material can be formed by polymerization or crosslinking.

As the materials of the mesh layer, hydrophobic materials such as nylon, polyethylene, Teflon, polystyrene can be applicable, but hydrophilic treatment on these hydrophobic materials is desirable. Punching sheet is produced by providing many holes in the sheet or so used as support that will be mentioned later, and each hole forms the mesh.

The mesh layer may be provided with the condition that can maintain specimen in each mesh. Besides, the mesh layer may be laminated with the support or the hydrophilic polymer layer by adhesive etc., or merely put on the support or on the hydrophilic polymer layer. The mesh layer may limit spreading of the sample, and may not limit the spreading of the sample.

The hydrophilic polymer layer should be provided next to the mesh layer, and it is desirable not to let other layer exist among these layers. Typical examples of the hydrophilic polymer as a matrix forming the hydrophilic polymer layer are well known various polymers such as water-soluble polymer, swelling polymer, and hydrophilic polymer used for conventional dry chemistry analytical elements.

Although examples as the hydrophilic polymer are polyvinyl alcohol, polyacrylamide, polyvinylpyrrolidone, polymethyl vinyl ether, copolymer of polyacrylamide and polyvinylpyrrolidone, methyl cellulose derivative, crosslinked starch-acrylate graft copolymer, crosslinked polyacrylic acid, gelatin (for example, acid treated gelatin, deionized gelatin), gelatin derivative (for example, phthalated gelatin, hydroxyacrylate graft gelatin), carboxymethylstarch, etc., it is not limited to these. It is desirable that the hydrophilic polymer layer is, in principle, transparent. The thickness of the hydrophilic polymer layer in dry state is properly from about 2 μm to about 100 μm, preferably from about 5 μm to about 50 μm.

As the water impermeable support, transparent water-impermeable support of public knowledge used for conventional dry analytical element can be applied.

As the example of the water impermeable support, transparent film of from about 50 μm to about 1 mm in thickness, desirably from about 80 μm to about 300 μm in thickness, consisting of polyethylene terephthalate, polycarbonate of bisphenol A, polystyrene, cellulose ester (for example, cellulose diacetate, cellulose triacetate, cellulose acetate propionate), etc., are applicable.

The support may be provided with a well-known undercoating layer or with a well known adhesion layer on its surface in order to strengthen the adhesion between the support and the hydrophilic polymer layer.

In the case where any hydrophilic polymer layer is not provided, the surface of the support itself of the mesh layer side of the dry analytical element must be hydrophilic at least in the degree that the sample can spread on the entire surface in the compartment partitioned with the mesh.

Therefore, when the support itself is repellent or hydrophobic, the support needs to be treated with hydrophilic treatment to the aforementioned degree.

Dry analytical element of this invention fundamentally consists of the support, the hydrophilic polymer layer, and the mesh layer and does not contain other layer.

However, a functional layer such as a water absorption layer of the dry analytical element can be provided between the hydrophilic polymer layer and the support. In the dry analytical element of FIG. 1, the water-impermeable support 1 and the water-impermeable frame body 2 are integrally formed, and dry matter 4 of the reagent that is necessary for analysis is arranged in the internal of the dry analytical element. In FIG. 1, the sample is designated by the numeral 5. In FIG. 2, reagent layer 3 which is hydrophilic polymer layer containing the reagent necessary for analysis is coated on water impermeable support 1, and frame body 2 is installed on the reagent layer 3, thereby forming the dry analytical element. In FIG. 3, the frame body 2 is provided surrounding an outer circumferential edge of the support 1 and the reagent layer 3, thereby forming the dry analytical element.

The configuration of compartment partitioned by the frame is not particularly limited, and tetragon, hexagon, circular, etc., are disclosed as example. Diameter indicating dimension of each block is adequately from about 0.05 mm to about 7.5 mm, preferably from 0.4 mm to 6 mm. The height of the frame body may be sufficient as the height that can maintain the sample, and is desirable to be 0.01 mm or more on the support, preferable to be from about 0.3 mm to about 1.0 mm on the support. When the hydrophilic polymer layer is applied on the support, the height of the frame body is defined as the height on the hydrophilic polymer layer.

As the materials of the frame body, hydrophobic materials such as nylon, polyethylene, Teflon, polystyrene can be applicable, but hydrophilic treatment on these hydrophobic materials is desirable.

The frame body may be adequate to be installed with the condition which can maintain the sample in the frame, and is sufficient to be assembled using adhesive etc., with the support or the hydrophilic polymer layer, even sufficient to be merely put on the support or the hydrophilic polymer layer. The above adhesive can be selected from, for example, the above-mentioned hydrophilic polymers.

Dry analytical element of the second invention fundamentally consists of frame body and the hydrophilic polymer layer and support, and does not contain other layer.

However, a functional layer such as a water absorption layer of conventional dry analytical element can be provided between the hydrophilic polymer layer and the support.

Dimension of the dry analytical element is adequate to be from about 1 mm to about 15 mm, usually from about 4 mm to about 12 mm when it is designated with the length of diameter in case of circle, or when it is designated with the length of side in case of tetragon.

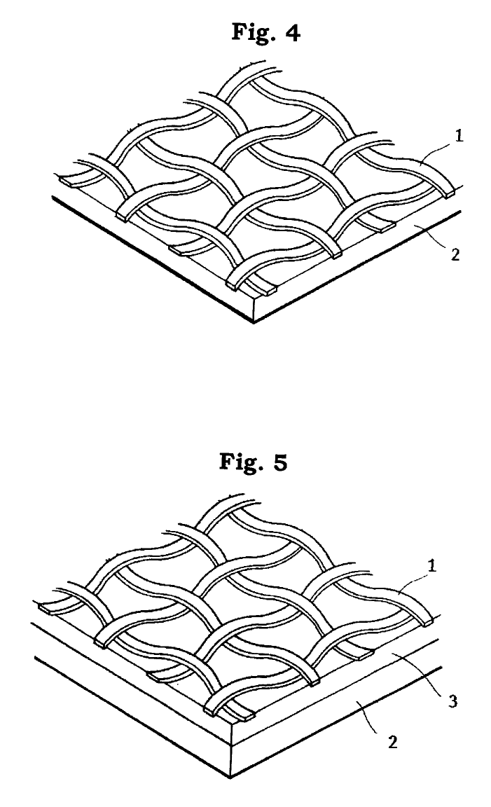

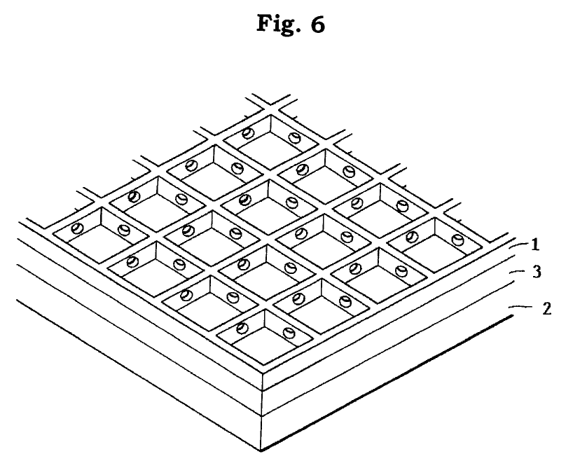

Examples of other structure of the dry analytical element of the present invention are shown in FIG. 4, FIG. 5 and FIG. 6.

In FIG. 4, the dry analytical element consists of net 1 and support 2.

In FIG. 5, the dry analytical element consists of net 1 and reagent layer 3 and support 2.

In FIG. 6, the dry analytical element consists of punching sheet 1, reagent layer 3, and support 2.

Dimension of the dry analytical element is adequate to be from about 1 mm to about 15 mm, usually from about 4 mm to about 12 mm when it is designated with the length of diameter in case of circle, or when it is designated with the length of side in case of tetragon. The dry analytical element is used in the frame body of plastic or so in the same way as conventional dry analytical element.

The mesh layer of this invention can be integrated with the frame body, or can be molded with the frame body to one-piece.

In the present invention, analyte to be measured is not particularly limited.

Any substance of which analysis has been established in clinical assay, can be analyzed by the device of the invention, such as, enzymes, lipids, inorganic ions, metabolites, proteins, various globulins, antigens, antibodies, medicines, hormones, tumor markers, DNA, RNA, etc.

It is desirable that the dry analytical element of this invention includes every reagent that is necessary for analysis. Such a reagent may be the same as the reagent included in the dry analytical element of public knowledge.

Every reagent that is necessary for analysis is the reagent that is necessary and indispensable, and other reagent may be appropriately added or eliminated. All reagents are, in principle, contained in each space in the frame or in the hydrophilic polymer layer.

In the second invention, all reagents are, in principle, contained in each space in the frame or in the hydrophilic polymer layer. As the method for incorporating the reagent into the dry analytical element, there are the method of coating the reagent solution or hydrophilic polymer solution containing the reagent on the support, the method of applying aerosol or dot of the reagent on the support, the method of using spin coating machine. As the drying of reagent, heating, depression, or freeze-drying, etc., are applicable depending on the thermal stability of the reagent.

On the other hand, the reagent can be added to the sample at the time of measurement without being contained in the dry analytical element beforehand. The addition of the reagent may be before, at the same time, or after the addition of the sample. The feeding volume of the sample is sufficient to be from about 5 μl to about 100 μl, usually from 5 μl to 60 μl. The condition of incubation is suitable to be similar as the condition of conventional dry analytical element. Photometry after the reaction is suitably selected from any direction of upper, bottom, or side part of the support, and either of reflection photometry or transmission photometry is adopted. A prism or a mirror can be usually utilized for the photometry.

### EXAMPLES

### Example 1

### Preparation of Dry Analytical Element A for Total Protein Determination

On the surface of the polyethylene terephthalate transparent film with gelatin undercoating of 180 μm in total thickness, the aqueous solution which had the following composition was coated and dried to form reagent layer.

| | |
|---|---|
| AA-NVP-MA copolymer: | 24.9 g/m² |
| Surfactant: | 5.4 g/m² |
| Glycerin: | 3.4 g/m² |
| Copper sulfate: | 12.5 g/m² |
| L (+) tartaric acid: | 7.3 g/m² |
| LiOH: | 13.4 g/m² |
| (+) Sodium hydrogen tartrate: | 0.9 g/m² |

Here, AA-NVP-MA copolymer is defined as acryl amide-vinylpyrrolidone-methallyl alcohol.

As the surfactant, polyoxy (2-hydroxy) propylene nonylphenylether (“Surfactant 10G”, made by Olin Corp.) was used.

Plastic sheet of 0.8 mm in thickness made by boring a hole in circular shape of a diameter of 1 cm was adhered as a frame body to the analytical element.

Subsequently, this analytical element was cut to chips of 12 mm×13 mm, and confined in slide frame (disclosed in Japanese Patent KOKAI 57-63542) thereby preparing the dry analytical element A for total protein determination of this invention.

### Comparative Example 1

### Preparation of Dry Analytical Element B for Total Protein Determination

On the surface of the polyethylene terephthalate transparent film with gelatin undercoating of 180 μm in total thickness, the aqueous solution which had the following composition was coated and dried to form reagent layer.

| | |
|---|---|
| AA-NVP-MA copolymer: | 24.9 g/m² |
| Surfactant: | 5.4 g/m² |
| Glycerin: | 3.4 g/m² |
| Copper sulfate: | 12.5 g/m² |
| L (+) tartaric acid: | 7.3 g/m² |
| LiOH: | 13.4 g/m² |
| (+) Sodium hydrogen tartrate: | 0.9 g/m² |

Here, AA-NVP-MA copolymer is defined as acryl amide-vinylpyrrolidone-methallyl alcohol.

As the surfactant, polyoxy (2-hydroxy) propylene nonylphenylether (“Surfactant 10G”, made by Olin Corp.) was used.

Subsequently, after the reagent layer was swelled by the application of water on the entire surface of the layer with feeding rate of about 30 g/m², a tricot knitting textile provided by knitting 50 denier polyethylene terephthalate spun yarn to 36 gauge was laminated by light press, and the whole layers were dried.

In this way, an integral multilayer analytical element was made having polyethylene terephthalate transparent film, reagent layer, and spreading layer in this sequence.

The integral multilayer analytical element was cut to chips of 12 mm×13 mm, and confined in slide frame (disclosed in Japanese Patent KOKAI 57-63542) thereby preparing the dry analysis element B for total protein determination of this invention.

### Measurement Example 1

The quantity of 50 μl of serum having total protein concentration of 4.0 g/dl, 6.5 g/dl, or 9.0 g/dl respectively was deposited onto the dry analytical element A of the Example 1. After incubating at 37° C. for five minutes, each analytical element was subjected to reflection photometry at 540 nm from the support side. A white board made by Teflon was arranged as a reflector at the reagent layer side of the dry analytical element A at the time of the reflection photometry.

Calibration curve was shown as the followings:

| Total protein concentration [g/dl] | OD (540 nm) |
|---|---|
| 4.0 | 0.50 |
| 6.5 | 0.64 |
| 9.0 | 1.06 |

OD range = OD (total protein: 9.0 g/dl)
− OD (total protein: 4.0 g/dl)
= 1.06-0.5
= 0.56

On the other hand, the quantity of 50 μl of serum having total protein concentration of 4.0 g/dl, 6.5 g/dl, and 9.0 g/dl respectively was deposited onto the dry analytical element B of the Comparative example 1. After incubating at 37° C. for five minutes, each analytical element was subjected to reflection photometry at 540 nm from the support side.

Calibration curve was shown as the followings:

| Total protein concentration [g/dl] | OD (540 nm) |
|---|---|
| 4.0 | 0.92 |
| 6.5 | 1.07 |
| 9.0 | 1.19 |

OD range = OD (total protein: 9.0 g/dl)
− OD (total protein: 4.0 g/dl)
= 1.19-0.92
= 0.27

From the above-described result, it is obvious that the OD range of Example 1 gains two times wider OD range than the comparative example 1.

### Example 2

### Preparation of Dry Analytical Element C for Human Chorionic Gonadotropin (HCG) Measurement

On the surface of the polyethylene terephthalate transparent film of 180 μm in thickness, the reagent solution was coated to the following coating amount and dried to form reagent layer.

Carboxymethylstarch: 5.8 g/m²

Anti HCG antibody-sensitized latex (particle size 2.5 μm): 1.6 g/m²

Bovine serum albumin: 1.6 g/m²

Plastic sheet of 0.8 mm in thickness made by boring a hole in circular shape of a diameter of 1 cm was adhered as a frame body to the analytical element.

Subsequently, this analytical element was cut to chips of 12 mm×13 mm, and confined in slide frame (disclosed in Japanese Patent KOKAI 57-63542) thereby preparing the dry analytical element C of Example 2.

### Comparative Example 2

### Preparation of Dry Analytical Element D for Human Chorionic Gonadotropin (HCG) Measurement

On the surface of the polyethylene terephthalate transparent film of 180 μm in thickness, the reagent solution was coated to the following coating amount and dried to form reagent layer.

Carboxymethylstarch: 5.8 g/m²

Anti HCG antibody sensitized latex (particle size 2.5 μm): 1.6 g/m²

Bovine serum albumin: 1.6 g/m²

Subsequently, after the reagent layer was swelled by the application of water on the entire surface of the layer with feeding rate of about 30 g/m², a tricot knitting textile provided by knitting 50 denier polyethylene terephthalate spun yarn to 36 gauge was laminated by light press, and the whole layers were dried.

In this way, an integral multilayer analytical element was made having polyethylene terephthalate transparent film, reagent layer, and development layer in this sequence. Subsequently, this analytical element was cut to chips of 12 mm×13 mm, and confined in slide frame (disclosed in Japanese Patent KOKAI 57-63542) thereby preparing the dry analytical element D of the Comparative example 2.

### Measurement Example 2

### Human Chorionic Gonadotropin (HCG) Measurement

The quantity of 50 μl of 0.5 IU/ml, 25 IU/ml, 100 IU/ml, or 500 IU/ml respectively of diluted solution of HCG made by SIGMA company diluted with 100 mM phosphoric acid buffer (pH 7.4) was deposited onto the dry analytical elements of the Example 2 and the Comparative example 2. After incubating at 37° C. for five minutes, each analytical element was subjected to reflection photometry at 650 nm from the support side. At the time of the reflection photometry, a black board was used as a color board for absorbing the light that transmits the reagent layer with the reaction among incoming beam from the support side.

Calibration curve was shown as the followings:

| | Example 2 | Comparative example 2 |
|---|---|---|
| HCG concentration [IU/ml] | OD (650 nm) | OD (650 nm) |
| 0 | 1.010 | 0.325 |
| 5 | 1.100 | 0.330 |
| 25 | 1.201 | 0.320 |
| 100 | 1.280 | 0.335 |
| 500 | 1.374 | 0.320 |

As shown in the above-exhibited calibration curve, the determination measurement of human chorionic gonadotropin was proved to be possible in the dry analytical element 3 of Example 2.

### Example 3

### Preparation of Dry Analytical Element E for Total Protein Determination

On the surface of the polyethylene terephthalate transparent film with gelatin undercoating of 180 μm in total thickness, the aqueous solution which had the following composition was coated and dried to form reagent layer.

| | |
|---|---|
| AA-NVP-MA copolymer: | 24.9 g/m² |
| Surfactant: | 5.4 g/m² |
| Glycerin: | 3.4 g/m² |
| Copper sulfate: | 12.5 g/m² |
| L (+) tartaric acid: | 7.3 g/m² |
| LiOH: | 13.4 g/m² |
| (+) Sodium hydrogen tartrate: | 0.9 g/m² |

Here, AA-NVP-MA copolymer is defined as acryl amide-vinylpyrrolidone-methallyl alcohol.

As the surfactant, polyoxy (2-hydroxy) propylene nonylphenylether (“Surfactant 10G”, made by Olin Corp.) was used.

The above analytical element was cut to chips of 12 mm×13 mm. Besides, polyethylene mesh made by fiber of 0.3 mm in diameter and having aperture of 0.8 mm×0.8 mm was also cut into chips of 12 mm×13 mm.

The chip of polyethylene mesh was put on said chip of analytical element, and these were confined in slide frame (disclosed in Japanese Patent KOKAI 57-63542) thereby preparing the dry analytical element E for total protein determination.

### Comparative Example 3

### Preparation of Dry Analytical Element F for Total Protein Determination

On the surface of the polyethylene terephthalate transparent film with gelatin undercoating of 180μm in total thickness, the aqueous solution which had the following composition was coated and dried to form reagent layer.

| | |
|---|---|
| AA-NVP-MA copolymer: | 24.9 g/m² |
| Surfactant: | 5.4 g/m² |
| Glycerin: | 3.4 g/m² |
| Copper sulfate: | 12.5 g/m² |
| L (+) tartaric acid: | 7.3 g/m² |
| LiOH: | 13.4 g/m² |
| (+) Sodium hydrogen tartrate: | 0.9 g/m² |

Here, AA-NVP-MA copolymer is defined as acryl amide-vinylpyrrolidone-methallyl alcohol.

As the detergent, polyoxy(2-hydroxy) propylene nonylphenylether (Surfactant 10G, made in Olin Corp.) was used.

Subsequently, after the reagent layer was swelled by the application of water on the entire surface of the layer with feeding rate of about 30 g/m², a tricot knitting textile provided by knitting 50 denier polyethylene terephthalate spun yarn to 36 gauge was laminated by light press, and the whole layers were dried.

In this way, an integral multilayer analytical element was made having polyethylene terephthalate transparent film, reagent layer, and spreading layer in this sequence.

The above integral multilayer analytical element was cut to chip of 12 mm×13 mm, and confined in slide frame (disclosed in Japanese Patent KOKAI 57-63542) thereby preparing the dry analytical element F for total protein determination.

### Measurement Example 3

The quantity of 50 μl of serum having total protein concentration of 4.0 g/dl, 6.5 g/dl, or 9.0 g/dl respectively was deposited onto the dry analytical element E of the Example 3 .

After incubating at 37° C. for five minutes, each analytical element was subjected to reflection photometry at 540 nm from the support side. A white board made by Teflon was arranged as a reflector at the reagent layer side of the dry analytical element 5 at the time of the reflection photometry.

Calibration curve was shown as the followings:

| Total protein concentration [g/dl] | OD (540 nm) |
|---|---|
| 4.0 | 0.65 |
| 6.5 | 1.02 |
| 9.0 | 1.25 |

OD range = OD (total protein,:, 9.0 g/dl)
− OD (total protein,:, 4.0 g/dl)
= 1.25-0.65
= 0.60

On the other hand, the quantity of 50 μl of serum having total protein concentration of 4.0 g/dl, 6.5 g/dl, or 9.0 g/dl respectively was deposited onto the dry analytical element 6 of Comparative example 3.

After incubating at 37° C. for five minutes, each analytical element was subjected to reflection photometry at 540 nm from the support side.

Calibration curve was shown as the followings:

| Total protein concentration [g/dl] | OD (540 nm) |
|---|---|
| 4.0 | 0.92 |
| 6.5 | 1.07 |
| 9.0 | 1.19 |

OD range = OD (total protein: 9.0 g/dl)
− OD (total protein: 4.0 g/dl)
= 1.19-0.92
= 0.27

From the above-described result, it is obvious that the OD range of Example 3 gains two times wider OD range than the Comparative example 3.

### Example 4

### Preparation of Dry Analytical Element G for Human Chorionic Gonadotropin (HCG)Measurement

On the surface of the polyethylene terephthalate transparent film of 180 μm in thickness, the reagent solution was coated to the following coating amount and dried to form reagent layer.

Carboxymethylstarch: 5.8 g/m²

Anti HCG antibody sensitized latex (particle size 2.5 μm): 1.6 g/m²

Bovine serum albumin: 1.6 g/m²

The above analytical element was cut to chips of 12 mm×13 mm. Besides, polyethylene mesh made by fiber of 0.3 mm in diameter and having aperture of 0.8 mm×0.8 mm was also cut into chips of 12 mm—13 mm.

The chip of polyethylene mesh was put on the chip of analytical element, and these were confined in slide frame (disclosed in Japanese Patent KOKAI 57-63542) thereby preparing the dry analytical element G for total protein determination.

### Comparative Example 4

### Preparation of Dry Analytical Element H for Human Chorionic Gonadotropin (HCG) Measurement

On the surface of the polyethylene terephthalate transparent film of 180 μm in thickness, the reagent solution was coated to the following coating amount and dried to form reagent layer.

Carboxymethylstarch: 5.8 g/m²

Anti HCG antibody sensitized latex (particle size 2.5 μm): 1.6 g/m²

Bovine serum albumin: 1.6 g/m²

Subsequently, after the reagent layer was swelled by the application of water on the entire surface of the layer with feeding rate of about 30 g/m², a tricot knitting textile provided by knitting 50 denier polyethylene terephthalate spun yarn to 36 gauge was laminated by light press, and the whole layers were dried.

In this way, an integral multilayer analytical element was made having polyethylene terephthalate transparent film, reagent layer, and development layer in this sequence.

Subsequently, this analytical element was cut to chips of 12 mm×13 mm, and confined in slide frame (disclosed in Japanese Patent KOKAI 57-63542) thereby preparing the dry analytical element H of the Comparative example 4.

### Measurement Example 4

### Human Chorionic Gonadotropin (HCG) Measurement

The quantity of 50 μl of 0.5 IU/ml, 25 IU/ml, 100 IU/ml, and 500 IU/ml respectively of diluted solution of HCG made by SIGMA company diluted with 100 mM phosphoric acid buffer (pH 7.4) was deposited onto the dry analytical elements of Example 4 and Comparative example 4.

After incubating at 37° C. for five minutes, each analytical element was subjected to reflection photometry at 650 nm from the support side.

At the time of the reflection photometry, a black board was used as a color board for absorbing the light that transmits the reagent layer with the reaction among incoming beam from the support side.

Calibration curve was shown as the followings:

| | Example 4 | Comparative example 4 |
|---|---|---|
| HCG concentration [IU/ml] | OD (650 nm) | OD (650 nm) |
| 0 | 1.110 | 0.325 |
| 5 | 1.170 | 0.330 |
| 25 | 1.268 | 0.320 |
| 100 | 1.346 | 0.335 |
| 500 | 1.437 | 0.320 |

As shown in the above-exhibited calibration curve, the determination measurement of human chorionic gonadotropin was proved to be possible in the dry analytical element G of Example 4.

The dry analytical element of this invention merges advantage of both wet process and dry process, and accordingly, makes it possible to measure rapidly, simply and easily with a small amount of sample.

Besides, the dry analytical element of this invention has the advantage that makes it possible to measure even if the analytical reaction contains agglutination reaction or coagulation reaction other than colorimetric analysis.

As many apparently widely different embodiments of this invention may be made without departing from the spirit and scope thereof, it is to be understood that the invention is not limited to the specific embodiments thereof except as defined in the appended claims.

What is claimed is:

1. A dry analytical element without any spreading layer wherein the upper surface of water impermeable support is partitioned by water impermeable frame body, and wherein reagent necessary for analysis is contained in the frame.

2. The dry analytical element as claimed in claim 1 wherein hydrophilic polymer layer is provided on said water impermeable support.

3. The dry analytical element as claimed in claim 2 wherein said hydrophilic polymer layer is the reagent layer including the reagent that is necessary for analysis.

4. The dry analytical element as claimed in claim 1, wherein the shape of the compartment partitioned by the frame is tetragon.

5. The dry analytical element as claimed in claim 1, wherein the shape of the compartment partitioned by the frame is hexagon.

6. The dry analytical element as claimed in claim 1, wherein the shape of the compartment partitioned by the frame is circular.

7. A dry analytical element comprising water impermeable support and mesh layer which is applied on said water impermeable support.

8. The dry analytical element as claimed in claim 7 wherein hydrophilic polymer layer is provided between said water impermeable support and said mesh layer.

9. The dry analytical element as claimed in claim 8 wherein said hydrophilic polymer layer is the reagent layer including the reagent that is necessary for analysis.

10. The dry analytical element as claimed in claim 9 wherein said mesh layer is punching sheet.

11. The dry analytical element as claimed in claim 7, wherein the shape of the mesh is tetragon.

12. The dry analytical element as claimed in claim 7, wherein the shape of the mesh is hexagon.

13. The dry analytical element as claimed in claim 7, wherein the shape of the mesh is circular.
